(19) United States
(12) Patent Application Publication
(10) Pub. No.: US 2012/0241071 A1
(43) Pub. Date: Sep. 27, 2012

(54) DOUBLE-SIDED PRESSURE-SENSITIVE ADHESIVE SHEET WITH RELEASE SHEETS

(75) Inventors: Kahoru Niimi, Shiga (JP); Makoto Inenaga, Shiga (JP)

(73) Assignee: Mitsubishi Plastics, Inc., Tokyo (JP)

(21) Appl. No.: 13/505,972

(22) PCT Filed: Oct. 29, 2010
(86) PCT No.: PCT/JP2010/069273

§ 371 Date: Jun. 8, 2012

(30) Foreign Application Priority Data
Nov. 6, 2009 (JP) 2009-255435

(51) Int. Cl. B32B 7/06; B32B 37/12

(52) U.S. Cl. 156/60; 428/41.8

(57) ABSTRACT

As a double-sided pressure-sensitive adhesive sheet with release sheets that does not become charged with static electricity even when the double-sided pressure-sensitive adhesive sheet with release sheets is turned into a roll, cut or superposed, proposed is a sheet formed in such a way that, in the double-sided pressure-sensitive adhesive sheet with release sheets comprising a pressure-sensitive adhesive layer and two release sheets on both the top and bottom sides of the pressure-sensitive adhesive layer, the pressure-sensitive adhesive layer side of at least one of the release sheets and the surface on the side opposite to the pressure-sensitive adhesive layer, i.e. the back surface, of the at least one of the release sheets have electric conductivity.

### TECHNICAL FIELD

The present invention relates to a double-sided pressure-sensitive adhesive sheet with release sheets, the double-sided adhesive sheet allowing two parts (adherends) to be adhered and comprising release sheets layered on both the top and bottom sides of an adhesive layer, respectively.

### TECHNICAL BACKGROUND

In order to bond together various optical parts used in display devices such as liquid crystal panels, PDPs and EL displays, double-sided adhesive sheets with release sheets are used in large numbers, comprising an adhesive shaped into sheet-form and release sheets layered on both the top and bottom sides of the adhesive layer. For instance, this type of double-sided adhesive sheet with release sheets is used in PDPs, in order to layer an anti-reflective film, a color-toning film and an electromagnetic wave shielding film sequentially on a glass plate.

In addition, recently, double-sided adhesive sheets with release sheets are being used, not only for the purpose of bonding such optical parts together, but also to improve visibility; for instance, in a liquid crystal display parts, the gap layer between a polarizer and the parts above is filled with an adhesive sheet.

Elsewhere, double-sided adhesive sheets with release sheets are used frequently for adhesion or immobilization of parts onto each other in many fields.

Incidentally, since materials formed from plastic, such as various optical members, adhesive and release sheets, have high electric insulation, when members rub against each other, or a release sheet is peeled from an adhesive sheet, or the like, they become charged by developing static electricity and sometimes give rise to various problems. For instance, if dust and dirt from the surroundings attach to the adhesive surface of an adhesive sheet due to static electricity, defects arise at the adhesion interface with the adherend, decreasing the adhesive strength over time, or, if a voltage is applied to a liquid crystal in a static-electricity-charged state, problems sometimes arise, such as the orientation of liquid crystal molecules is lost, or a defect occurs in the liquid crystal panel.

Thus, in regard to double-sided adhesive sheet with release sheets, a variety of schemes have been proposed in order to avoid charge static electricity in prior art.

For instance, providing antistatic capabilities to an adhesive sheet by mixing an ionic solution into an adhesive composition is described in Patent Reference 1.

An antistatic adhesive is described in Patent Reference 2, containing an acrylic copolymer (A) having a hydroxyl group and an alkylene oxide chain as side chains, an ionic compound (B), a hardener (C) and an oxidation inhibitor (D).

An antistatic photosensitive laminate is disclosed in Patent Reference 3, having an antistatic cover film, a polyvinyl alcoholic adhesion-prevention layer, a photosensitive resin layer and a support film.

In addition, an adhesive composition is described in Patent Reference 4, containing an ionic solution in which the anionic constituent is a sulfonate anion or an ester sulfate anion, and a base polymer whose glass transition temperature (Tg) is 0° C. or lower. An adhesive layer in which the adhesive composition has been crosslinked is intended to prevent from charging of a body targeted for protection (adherend) that is not prevented from being charged when the adherend is peeled, decreases contamination of the body subjected for protection, and has excellent adhesive properties.

An adhesive is described in Patent Reference 5, containing an adhesive resin and an electrical conducting material, in which the charge potential of the adhesive layer surface is a specific value or lower when the release film is peeled from the adhesive layer.

### PRIOR ART REFERENCES

### [Patent References]

[Patent Reference 1] Japanese Patent Application Laid-open No. 2006-342191

[Patent Reference 2] WO2006/137559

[Patent Reference 3] Japanese Patent No. 3893568

[Patent Reference 4] Japanese Patent Application Laid-open No. 2007-70400

[Patent Reference 5] Japanese Patent Application Laid-open No. 2008-032852

### SUMMARY OF THE INVENTION

### Problems to be Solved by the Invention

As described above, the antistatic measures for double-sided adhesive sheet with release sheets proposed in prior art are ones that prevent the adhesive sheet per se from being charged, thereby preventing charging with static electricity that arises when a release sheet is peeled from the adhesive sheet.

However, generation of static electricity and charging occur also in cases other than peeling a release sheet, for instance, when a double-sided adhesive sheet with release sheets is turned into a roll or is cut, or when double-sided adhesive sheets with release sheets are stacked over one another during storage or during transport, sometimes leading to a variety of work disturbances.

Thus, the present invention proposes a novel double-sided adhesive sheet with release sheets that does not become charged with static electricity, not only when a release sheet has been peeled from the adhesive sheet, but also when, for instance, the double-sided adhesive sheet with release sheets is turned into a roll or is cut, or when double-sided adhesive sheets with release sheets are stacked over one another.

### Means to Solve the Problems

In order to solve such problems, the present invention proposes a double-sided adhesive sheet with release sheets, the double-sided adhesive sheet with release sheets comprising a adhesive layer and two release sheets layered on both the top and bottom sides of the adhesive layer, in which the peel strength between one release sheet and the adhesive layer, and the peel strength between the other release sheet and the adhesive layer are different, and the adhesive layer side of at least one of the release sheets and the surface opposite to the adhesive layer, i.e., the back surface, of the at least one of the release sheets have electric conductivity.

### Effects of the Invention

In the double-sided adhesive sheet with release sheets, since the release sheet side on the pressure-sensitive adhesive layer has electric conductivity, even if static electricity is generated when a release sheet is peeled from the adhesive sheet, electricity can be removed by releasing static electricity through the adhesive layer side, such that the double-sided adhesive sheet with release sheets does not become charged.

In addition, if the surface opposite to the adhesive layer, i.e. the back surface, of the at least one of the release sheets has electric conductivity, even if static electricity is generated, for instance, when a double-sided adhesive sheet with release sheets is turned into a roll or is cut, or when double-sided adhesive sheets with release sheets are stacked over one another, electricity can be removed by releasing static electricity through the back surface, such that the double-sided adhesive sheet with release sheets does not become charged.

Thus, according to the double-sided adhesive sheet with release sheets of the present invention, the double-sided adhesive sheet with release sheets does not become charged with static electricity, not only when a release sheet has been peeled from the adhesive sheet, but also when the double-sided adhesive sheet with release sheets is turned into a roll or is cut, or when double-sided adhesive sheets with release sheets are stacked over one another.

Therefore, the double-sided adhesive sheet with release sheets of the present invention can be suitably used, particularly in applications in which static electricity is unwanted, for instance, electronic instruments such as cellular phones, PHS, PDA terminals, portable gaming machines, PCs, car navigation devices, and digital cameras, or for automotive industries which demand high environmental reliability, and the like.

### [BRIEF DESCRIPTION OF THE DRAWINGS]

FIG. 1 (A) to (F) are exploded cross-sectional views showing constitution examples of respective double-sided adhesive sheets with release sheets of the present invention. In the drawings, the surface indicated by “xxx” is the surface having electric conductivity.

FIG. 2 An exploded cross-sectional view showing an example of the double-sided adhesive sheets with release sheets of the present invention.

FIG. 3 An exploded cross-sectional view showing an example of the double-sided adhesive sheets with release sheets of the present invention.

FIG. 4 An exploded cross-sectional view showing an example of the double-sided adhesive sheets with release sheets of the present invention.

FIG. 5 An exploded cross-sectional view showing a Comparative Example of the double-sided adhesive sheets with release sheets of the present invention.

FIG. 6 An exploded cross-sectional view showing a Comparative Example of the double-sided adhesive sheets with release sheets of the present invention.

FIG. 7 An exploded cross-sectional view showing a Comparative Example of the double-sided adhesive sheets with release sheets of the present invention.

FIG. 8 An exploded cross-sectional view showing a Comparative Example of the double-sided adhesive sheets with release sheets of the present invention.

### MODE FOR CARRYING OUT THE INVENTION

Next, examples of embodiments of the present invention will be described; however, the scope of the present invention is not limited to the embodiments described herein.

The double-sided adhesive sheet with release sheets according to the present embodiment (hereafter noted “the present adhesive sheet”) is a double-sided adhesive sheet with release sheets provided with a constitution in which a release sheet 1, an adhesive layer 2 and a release sheet 3 are sequentially layered, the adhesive layer side (1a, 3a) of at least one of the release sheet 1 and the release sheet 3, and at least the surfaces opposite to the adhesive layer, i.e., the back surface (1b, 3b), of the at least one of the release sheet 1 and release sheet 3, having electric conductivity.

In so doing, the adhesive layer 2 per se, or the adhesive surfaces (2a, 2b) of the adhesive layer 2 may have or may not have electric conductivity.

In addition, the present adhesive sheet may be provided with other layer than the release sheet 1, the adhesive layer 2 and the release sheet 3.

### <Layered Constitution>

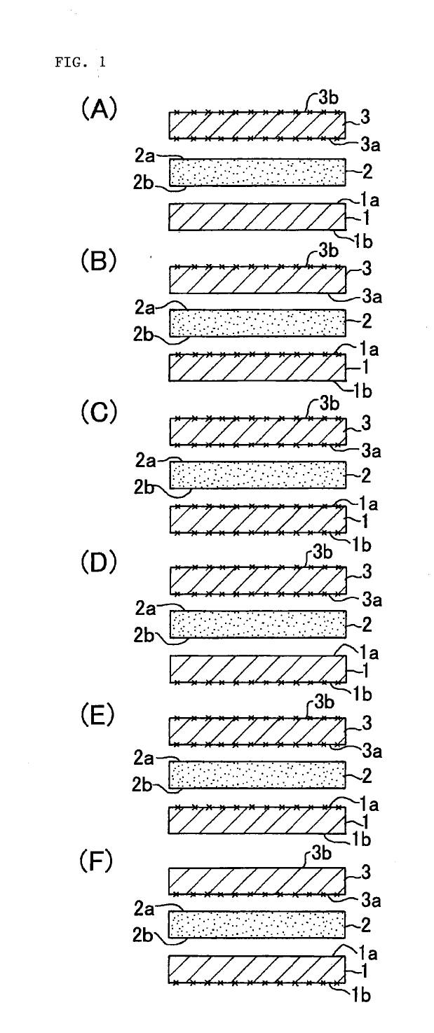

For instance, as shown in FIG. 1(A), the constitution can be such that only an adhesive layer side 3a of an adhesive layer 3 and a back surface 3b thereof have electric conductivity, and in addition, as shown in FIG. 1(B), the constitution can also be such that only an adhesive layer side 1a of a release sheet 1 and a surface on the side opposite to the adhesive layer, i.e., a back surface 3b, of a second release sheet 3, have electric conductivity. As shown in FIG. 1(C), the constitution can also be such that an adhesive layer side 1a of an adhesive layer 1 and a back surface 1b thereof, the adhesive layer side 3a of the adhesive layer 3 and the back surface 3b thereof, have electric conductivity. In addition, as shown in FIG. 1(D), the constitution can also be such that the surface on the side opposite to the adhesive layer, i.e., a back surface 1b of the release sheet 1, the adhesive layer side 3a of the adhesive layer 3 and the back surface 3b thereof have electric conductivity. Furthermore, as shown in FIG. 1(E), the constitution can also be such that the adhesive layer side 1a of the release sheet 1, the adhesive layer side 3a of the release sheet 3 and the back surface 3b thereof have electric conductivity, and in addition, as shown in FIG. 1(F), the constitution can also be such that the back surface 1b of the release sheet 1 and the adhesive layer side 3a of the release sheet 3 have electric conductivity.

In so doing, it is desirable that the peel strength between the release sheet 1 and the adhesive layer 2, and the peel strength between the second release sheet 3 and the adhesive layer 2 are different. For instance, by rendering the peel strength between the second release sheet 3 and the adhesive layer 2 greater than the peel strength between the release sheet 1 and the adhesive layer 2 so that the release sheet 1 is peeled more easily than the release sheet 3, a series of operations comprising peeling the release sheet 1, bonding the adhesive layer 2 to an adherend and then peeling the release sheet 3 can be carried out efficiently.

When the peel strength between the second release sheet 3 and the adhesive layer 2 is to be greater than the peel strength between the release sheet 1 and the adhesive layer 2 in this way, while the constitution can be such that the back surface 3b of the release sheet 3 with the greater peel strength has electric conductivity, a constitution, as shown in FIGS. 1(A), (C), (D), (E) and (F), such that the adhesive layer side 3a of the release sheet 3 with the greater peel strength has electric conductivity, rather, is all the more desirable.

If electric conductivity is given to the adhesive layer side 3a of the release sheet 3 with the greater peel strength, i.e., of the two release sheets 1 and 3, the release sheet 3, which is the one that remains behind, it is desirable on the point that, for instance when peeling the release sheet 1 and adhering the present adhesive sheet to an adherend, not only the static electricity generated when the release sheet 1 is peeled can be released through the adhesive layer side 3a of the release sheet 3, even if static electricity were generated when the release sheet 3 is peeled subsequently, a release through the adhesive layer side 3a is possible.

In addition, as shown in FIGS. 1(A), (C), (D) and (E), a constitution such that the adhesive layer side 3a of the adhesive layer 3 of the release sheet 3 with the greater peel strength and the back surface 3b thereof have electric conductivity is all the more desirable.

In this way, if the back surface 3b of the release sheet 3, which remains behind, has electric conductivity, even if static electricity is generated, for instance, by cutting or stacking the present adhesive sheet in a state where it has been adhered to an adherend by peeling the release sheet 1, the adhesive layer 2 does not become charged, since the static electricity can be released through the back surface 3b.

### <Forming Means>

In order to impart electric conductivity to one side or each side of the release sheet 1 and the release sheet 3, it suffices to form an electrical conducting layer on one side or each side of the release sheets 1 and 3. In so doing, on the side where the release layer is to be formed, the release layer is formed on the outside of the electrical conducting layer; however, since the release layer is thin, this surface has electric conductivity even if there is no electrical conducting layer on the surface.

In addition, to impart electric conductivity to each side of the release sheet 1 and the release sheet 3, forming by kneading a conductive material in and shaping the release sheet 1 and the release sheet 3 so that the release sheet 1 and the release sheet 3 in their entireties have electric conductivity, in other words, so that the release sheet 1 and the release sheet 3 per se become electrical conducting layers, is also possible.

A detailed description is given hereafter.

(Electrical Conducting Layer)

It suffices that the electrical conducting layer is formed as a layer containing an electrical conducting material. For instance, forming is possible by coating the surface of a release sheet with a composition containing an electrical conducting material and a binder or a crosslinking agent.

As electrical conducting materials, ion-conducting agents, ionic solutions, surfactants, and the like, may be cited. Concretely, for instance, cationic conducting agents containing a cationic functional group, such as a quaternary ammonium salt, a pyridinium salt, or a primary to tertiary amino group, anionic conducting agents having an anionic functional group, such as a sulfonate group, a sulfate ester base, a phosphoester base, or a phosphonate group, amphoteric conducting agents such as of the amino acid series or the amino sulfate ester series, organic antistatic compounds having a non-ionic functional group such as of the polyol series, the polyglycerol series or the polyethyleneglycol series, in addition, electrically conductive polymers such as polyaniline, polypyrrole and polythiophene, and inorganic electrically conductive fillers including tin and antimonial series fillers, indium oxide series, can be cited as preferred examples.

(Adhesive Layer)

An adhesive layer can be formed using a currently well-known adhesive composition, and for instance forming from a transparent material is desirable when it is used to adhere an optical material such as of an integrated image display device.

Adhesive layers that are of the substrateless-type, which have no substrate, are more desirable. With the substrateless type, there is no layering process for the substrate layer and the adhesive material layer, which is desirable, as there is no risk that a foreign matter becomes mixed into the layer interface, which may occur during layering.

In addition, by being substrateless, the adhesive material layer does not loose the softness it possesses, has excellent flexibility and adherend-following ability, and furthermore, a decrease in optical quality, such as interference in the transmitted beam, which may occur when the layer is turned into a laminate with different refractive indices, or a loss of isotropy or transparency of the adhesive sheet due to anisotropy or hazing originating from the substrate, has no risk of occurring, which is desirable.

From such points of view, for instance, polymers such as of the acrylic series, silicon series, polyurethane series, styrene series, polyester series, polyether series and epoxy series can be cited as base polymers (main agents) of the adhesive layer, and for the character (morphology) thereof, those with various characters can be used, such as, liquid body, highly viscous body and elastomeric body. An adhesive layer can be formed by selecting such base polymers suitably.

Among the base polymers mentioned above, using acrylic series, in particular (meth) acrylic acid ester polymer (including copolymers) as the base polymer, and crosslinking this to form an adhesive layer is desirable.

As acrylic monomers or methacrylic monomers used in order to synthesize (meth)acrylic acid ester polymers, for instance, 2-ethylhexyl acrylate, n-octyl acrylate, n-butyl acrylate, ethyl acrylate, and the like, may be cited. To these main monomers, it is possible to add suitably a crosslinking monomer such as hydroxyethyl acrylate, acrylic acid, itaconic acid, glycidyl acrylate, glycidyl methacrylate, methylol acrylamide or anhydrous maleic acid, a high aggregation monomer or a functional group-containing monomer such as methyl methacrylate, methyl acrylate, acrylamide, acrylonitrile, methacrylonitrile, vinyl acetate, styrene, fluorine acrylate or silicon acrylate. These monomers are polymerized by a well-known polymerization method such as solution polymerization, emulsion polymerization, block polymerization or suspension polymerization. In so doing, a polymerization initiator such as a thermal polymerization initiator or a photo-polymerization initiator may be used according to the polymerization method.

As crosslinking agents constituting the adhesive layer, isocyanate series crosslinking agent, epoxy series crosslinking agent, and the like, can be cited, of which one species, two species or more can be used.

As isocyanate series crosslinking agents, isocyanate monomers such as tolylene diisocyanate, chlorphenylene diisocyanate, hexamethylene diisocyanate, tetramethylene diisocyanate, isophorone diisocyanate, xylylene diisocyanate, diphenylmethane diisocyanate and hydrogenated diphenylmethane diisocyanate, isocyanate compounds and isocyanurated compounds from the addition of trimethylol propane or the like to these isocyanate monomers, burette-type compounds, furthermore, urethane prepolymer-type isocyanates from the addition reaction of well-known polyether polyol, polyester polyol, acrylic polyol, polybutadiene polyol, polyisoprene polyol, and the like, can be cited.

As epoxy series crosslinking agents, ethylene glycol glycidylether, polyethyleneglycol diglycidylether, glycerin diglycidylether, glycerin triglycidylether, 1,3-bis(N,N-diglycidylaminomethyl)cyclohexane, N,N,N″,N″-tetraglycidyl-m-xylylene diamine, N,N,N″,N″-tetraglycidylaminophenyl methane, triglycidyl isocyanurate, m-N,N-diglycidylaminophenyl glycidyl ether, N,N-diglycidyl toluidine, N,N-diglycidyl aniline, and the like, can be cited. As examples of aziridine series crosslinking agents, diphenyl methane-4,4″-bis(1-aziridinecarboxamide), trimethylolpropane tri-β-aziridinylpropionate, tetramethylol methane tri-β-aziridinylpropionate, toluene-2,4-bis(1-aziridinecarboxamide), triethylene melamine, bisisophthaloyl-1-(2-methylaziridine), tris-1-(2-methylaziridine)phosphine, trimethylolpropane tri-β-(2 methylaziridine)propionate, and the like, can be cited.

Alternatively to the crosslinking agents mentioned above, crosslinking monomers can also be used.

As crosslinking monomers, using acrylic crosslinking monomers is desirable, among which, rather than monofunctional (meth)acrylates, multifunctional (meth)acrylates such as bifunctional (meth)acrylates, trifunctional (meth)acrylates and tetrafunctional (meth)acrylates, or mixtures comprising two or more species of monofunctional to tetrafunctional (meth)acrylates mixed are desirable.

As monofunctional (meth) acrylates, (meth)acrylic acids such as acrylic acid, methacrylic acid and crotonic acid, lauryl acrylate, 2-ethylhexyl acrylate, 2-hydroxyethyl acrylate, 2-hydroxypropyl acrylate, tetrahydrofurfuryl acrylate, 1,6-hexanediol monoacrylate and dicyclopentanediene acrylate, and the like, can be cited.

As bifunctional (meth) acrylates, 1,3-butanediol diacrylate, 1,4-butanediol diacrylate, 1,6-hexanediol diacrylate, 1,9-nonanediol diacrylate, diethyleneglycol diacrylate, polyethyleneglycol 400 diacrylate and tripropyleneglycol diacrylate, and the like, can be cited.

As trifunctional (meth) acrylates, triacylates such as pentaerythritol triacylate, trimethylol propane triacylate, trimethylol propane PO-modified triacylate, and trimethylol propane EO-modified triacylate, trimethacrylates thereof, and the like, can be cited.

As tetrafunctional (meth) acrylates, ditrimethylol propane tetra acrylate, pentaerythritol tetra acrylate, and the like, can be cited.

The crosslinking monomers are not limited to the (meth)acrylates indicated above as examples, and for instance (meth)acrylate monomers containing an organic functional group, or the like, can also be used suitably.

The amount of crosslinking monomer added is preferably in a range of 0.5 to 25 parts by mass with respect to 100 parts by mass of base polymer.

In cases where the crosslinking monomers described above are used, photo-initiators or thermal polymerization initiators can be used as various crosslinking initiators, with the photo-initiators being particularly desirable.

As photo-initiators, either of cleavage-type photo-initiators and hydrogen abstraction-type photo-initiators can be used, of which hydrogen abstraction-type photo-initiators are desirable. As hydrogen abstraction-type photo-initiators, for instance, any among benzophenone, Michler ketone, dibenzosuberone, 2-ethyl anthraquinone, isobutyl thioxanthone and the like, or derivatives thereof, or mixed constituents comprising combinations of two or more species among these can be used. However, there is no limitation to the substances cited previously as hydrogen abstraction-type photo-initiators. In addition, hydrogen abstraction-types and cleavage-types may be used in combination in a variety of proportions.

The amount of photo-initiator added is not limited in particular, and in general adjusting it within a proportion range of 0.1 to 5 parts by mass with respect to 100 parts by mass of base polymer is adequate. However, this range may be exceeded by balancing with other elements.

In addition to the constituents indicated above, as necessary, various additives can be mixed suitably, including a colorant such as a pigment or a dye having near-infrared radiation-absorbing properties, a tackifier, an oxidation inhibitor, an anti-aging agent, a moisture absorbent, an ultraviolet light absorbent, a silane-coupling agent, natural or synthetic resins and the like.

(Release Sheet)

A release sheet can be formed by providing a parting layer (also referred to as a “release layer”) on either side of a parting support film.

Well-known resin films can be used arbitrarily for parting support films, and in particular, films having high transparency are desirable. For instance, polyester films, polycarbonate films, triacetyl cellulose films, polypropylene films, polyethylene films, and the like, can be cited. Among these, polyester films that excel in productivity and processability are desirable, and biaxially stretched polyethylene terephthalate films are particularly desirable.

The thickness of the support film is preferably 25 μm to 250 μm, and more preferably 50 μm to 125 μm.

A parting layer can be formed via a conventional printing method such as gravure-printing method, screen-printing method or offset printing method, by coating and drying (curing for curing coating-films such as thermosetting resins, ultraviolet light-curing resins, electron beam-curing resins and radiation-curing resins), for instance, a coating comprising a resin such a silicon resin, fluorine resin, aminoalkyd resin, polyester resin, paraffin wax, acrylic resin, urethane resin, melamine resin, urea resin, urea-melamine system, cellulose and benzoguanamine, and a surfactant, alone or a mixture thereof as the main constituent dissolved in an organic solvent or water. In particular, performing release treatment by silicon or fluorine compound, alkyd resin series release treatment agent, or the like is desirable.

<Physical Properties>

It is desirable for the present adhesive sheet that the charge potential of the double-sided adhesive sheet with release sheets as measured according to JIS L1094 meets the following conditions (1) and (2).

(1) It is desirable that the equilibrium charge potential of the back surface of at least one of the release sheets is 100 V or lower.

Above all, when the peel strength between the first release sheet and the adhesive layer, and the peel strength between the second release sheet and the adhesive layer are to be different, it is desirable that the equilibrium charge potential of the back surface of the release sheet with the greater peel strength is 100 V or lower.

This equilibrium charge potential is an index showing the nature of being difficult to be charged with static electricity, and if it is 100 V or lower, the release sheet can be evaluated as being difficult to be charged with static electricity.

(2) It is desirable that the charge potential half-time of the exposed adhesive surface of the adhesive layer is less than 60 seconds when at least one of the release sheets is peeled.

Above all, when the peel strength between the first release sheet and the adhesive layer, and the peel strength between the second release sheet and the adhesive layer are to be different, it is desirable that the charge potential half-time of the exposed adhesive surface of the adhesive layer when the release sheet with the greater peel strength is peeled is less than 60 seconds.

This charge potential half-time is an index of having an excellent electricity-removal effect, and if less than 60 seconds, the release sheet can be evaluated as having excellent electricity-removal effect. From such point of view, less than 40 seconds is more desirable, and in particular less than 30 seconds is more desirable.

<Application>

Even if static electricity is generated when a release sheet is peeled from the adhesive sheet, the present adhesive sheet does not become charged since electricity can be removed by releasing static electricity. In addition, even if static electricity is generated when the present adhesive sheet is turned into a roll or is cut, or when present adhesive sheets are stacked over one another, they do not become charged since electricity can be removed by releasing static electricity.

Thus, the present adhesive sheet can be suitably used, particularly in applications in which static electricity is unwanted, for instance, electronic instruments such as cellular phones, PHS, PDA terminals, portable gaming machines, PCs, car navigation devices, and digital cameras, or for automotive industries which demand high environmental reliability, and the like.

In particular, by forming the adhesive layer 2 from a transparent material, suitable use is possible when manufacturing an integrated image display device, for instance, in a liquid crystal display member, filling the gap layer between a polarizer and the member thereabove with an adhesive sheet to improve visibility.

### EXAMPLES

### Example 1

A polyethylene terephthalate film (PET manufactured by NIPPA Co., Ltd., “75-1-K0-ASI5”; thickness: 75 μm) 5A comprising on one side of a film an electrical conducting layer 5C and a release layer 5D layered in this order (: Support 1 in Table 1) was coated on the other side with an electrical conducting material coating (manufactured by Dainichiseika Color & Chemicals Mfg. Co., Ltd, “NEOCON COAT 567”), which was dried to form an electrical conducting layer 5B to constitute a release sheet 5.

For the second release sheet 7, a polyethylene terephthalate film (PET manufactured by NIPPA Co., Ltd, “38-1-A3”; thickness: 38 μm) 7A comprising a release layer 7B formed on one side of a film was used (: Support 2 in Table 1).

Copolymerized were 75 parts by weight of 2-ethylhexyl acrylate, 22 parts by weight of methyl acrylate and 3 parts by weight of acrylic acid to constitute an adhesive polymer (A), mixed with respect to 100 parts by weight of which were 1 part by weight of pentaerythritol triacylate as crosslinking agent and 3 parts by weight of 2-benzoyl benzoic acid as photo-polymerization initiator to constitute an adhesive composition, which was coated to a thickness of 150 μm with an applicator, layered so as to be sandwiched between the release sheet 5 and the release sheet 7 as shown in FIG. 2, and irradiated with ultraviolet from each side through the release sheet 5 and the release sheet 7 to crosslink the adhesive layer and produce a double-sided adhesive sheet with release sheets (electrical conducting layer/PET/electrical conducting layer/release layer//adhesive layer//release layer/PET).

The peel strengths when the release sheet 5 and the release sheet 7 were peeled from the adhesive 6 at 90° peel angle and 300 mm/minute peel speed were respectively 95 g/50 mm and 52 g/50 mm, confirming that the peel strength between the release sheet 5 and the adhesive layer 6 was greater than the peel strength between the release sheet 7 and the adhesive layer 6.

### Example 2

A polyethylene terephthalate film (manufactured by Toray, “LUMIRROR X53”; thickness: 100 μm) 8A comprising an electrical conducting material kneaded-in (: Support 1 in Table 1) was coated on one side with a parting agent composition comprising, mixed with respect to 100 parts by weight of an addition-type silicon (manufactured by Toray Dow Corning, SD7320), 0.5 parts by weight of curing platinum catalyst (manufactured by Toray Dow Corning, NC-25), which was dried to form a release layer 8B and produce a release sheet 8.

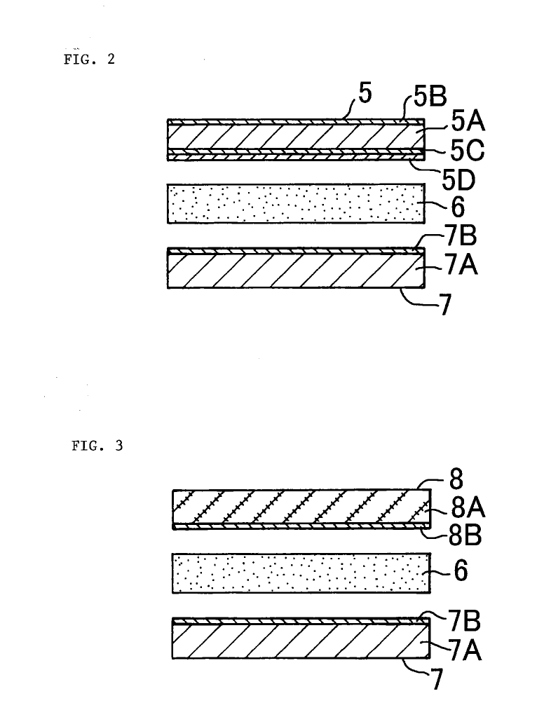

A double-sided adhesive sheet with release sheets (electrical conducting material-kneaded PET/release layer//adhesive layer//release layer/PET) was produced similarly to Example 1, except that, as shown in FIG. 3, in lieu of the release sheet 5, the release sheet 8 was used in Example 1.

The peel strengths when the release sheet 8 and the release sheet 7 were peeled from the adhesive 6 at 90° peel angle and 300 mm/minute peel speed were respectively 180 g/50 mm and 50 g/50 mm, confirming that the peel strength between the release sheet 8 and the adhesive layer 6 was greater than the peel strength between the release sheet 7 and the adhesive layer 6.

### Example 3

A polyethylene terephthalate film (PET manufactured by NIPPA Co., Ltd., “75-1-K2-ASI5”; thickness: 75 μm) comprising on one side of a film an electrical conducting layer 9B and a release layer 9C layered in this order (: Support 1 in Table 1) was used as a first release sheet 9.

Meanwhile, a polyethylene terephthalate film (manufactured by PANAC Corporation, “PANACREA AS-F”; 75 μm) having an electrical conducting layer 10B (: Support 2 in Table 1) was coated on the side where the electrical conducting layer is not formed with a parting agent composition obtained by mixing with respect to 100 parts by weight of silicon resin (manufactured by Shin-Etsu SiliconeKS-779H) 1 part by weight of hardener (manufactured by Shin-Etsu SiliconeCAT-PL-50T), which was dried to form a release layer 10C and produce a release sheet 10.

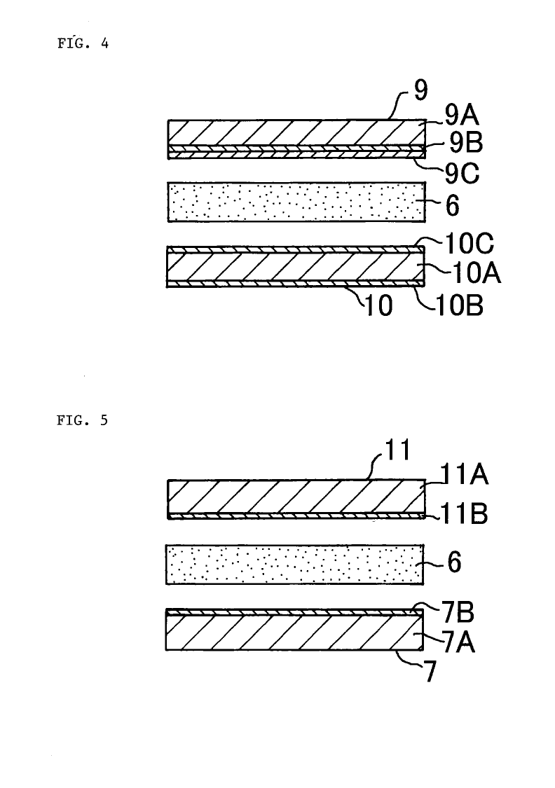

A double-sided adhesive sheet with release sheets (PET/electrical conducting layer/release layer//adhesive layer//release layer/PET/electrical conducting layer) was produced similarly to Example 1, except that, as shown in FIG. 4, in lieu of the release sheet 5 and the release sheet 7, the release sheet 9 and the release sheet 10 were used in Example 1.

The peel strengths when the release sheet 9 and the release sheet 10 were peeled from the adhesive 6 at 90° peel angle and 300 mm/minute peel speed were respectively 130 g/50 mm and 60 g/50 mm, confirming that the peel strength between the release sheet 9 and the adhesive layer 6 was greater than the peel strength between the release sheet 10 and the adhesive layer 6.

### Comparative Example 1

A double-sided adhesive sheet with release sheets (PET/release layer//adhesive layer//release layer/PET) was produced similarly to Example 1, except that, as shown in FIG. 5, in lieu of the release sheet 5, a release sheet (manufactured by NIPPA Co., Ltd., “PET75-1-KX0”; thickness: 75 μm) 11 comprising a polyethylene terephthalate film 11A (: Support 1 in Table 1) and a release layer 11B was used in Example 1.

The peel strengths when the release sheet 11 and the release sheet 7 were peeled from the adhesive 6 at 90° peel angle and 300 mm/minute peel speed were respectively 100 g/50 mm and 48 g/50 mm, confirming that the peel strength between the release sheet 11 and the adhesive layer 6 was greater than the peel strength between the release sheet 7 and the adhesive layer 6.

### Comparative Example 2

A double-sided adhesive sheet with release sheets (PET/release layer//adhesive layer//release layer/PET/electrical conducting layer) was produced similarly to Example 3, except that, as shown in FIG. 6, in lieu of the release sheet 9, the release sheet 11 used in Comparative Example 1 was formed in Example 3.

The peel strengths when the release sheet 11 and the release sheet 10 were peeled from the adhesive 6 at 90° peel angle and 300 mm/minute peel speed were respectively 90 g/50 mm and 60 g/50 mm, confirming that the peel strength between the release sheet 11 and the adhesive layer 6 was greater than the peel strength between the release sheet 10 and the adhesive layer 6.

### Comparative Example 3

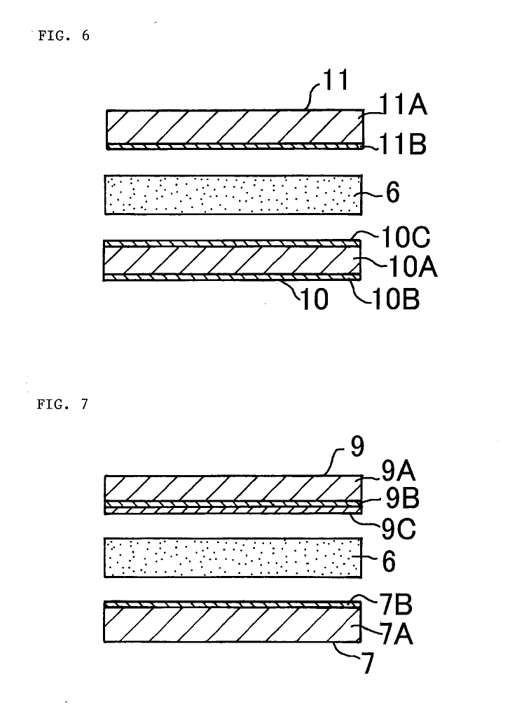

A double-sided adhesive sheet with release sheets (PET/electrical conducting layer/release layer//adhesive layer//release layer/PET) was produced similarly to Example 1, except that, as shown in FIG. 7, in lieu of the release sheet 5, the release sheet 9 used in Example 3 was used in Example 1.

The peel strengths when the release sheet 9 and the release sheet 7 were peeled from the adhesive 6 at 90° peel angle and 300 mm/minute peel speed were respectively 143 g/50 mm and 50 g/50 mm, confirming that the peel strength between the release sheet 9 and the adhesive layer 6 was greater than the peel strength between the release sheet 7 and the adhesive layer 6.

### Comparative Example 4

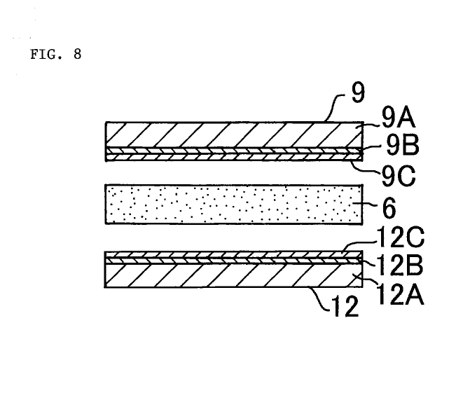

A double-sided adhesive sheet with release sheets (PET/electrical conducting layer/release layer//adhesive layer//release layer/electrical conducting layer/PET) was produced similarly to Example 1, except that, as shown in FIG. 8, in lieu of the release sheet 5, the release sheet 9 used in Example 3 was used, while in lieu of the release sheet 7, a release sheet (PET manufactured by NIPPA Co., Ltd., “75-1-HSP-ASI5”; thickness: 75 μm) 12 having an electrical conducting layer 12B and a release layer 12C on one side of a polyethylene terephthalate film 12A (: Support 2 in Table 1) was used in Example 1.

The peel strengths when the release sheet 9 and the release sheet 12 were peeled from the adhesive 6 at 90° peel angle and 300 mm/minute peel speed were respectively 180 g/50 mm and 52 g/50 mm, confirming that the peel strength between the release sheet 9 and the adhesive layer 6 was greater than the peel strength between the release sheet 12 and the adhesive layer 6.

### <Physical Property Tests>

The following measurements were carried out on the supports used, and the double-sided adhesive sheet with release sheets produced, in Examples 1 to 3 and Comparative Examples 1 to 4. The results are shown in Table 1.

(Measurement 1)

The equilibrium charge potential when a voltage of +10 kV was applied on the outer surface (i.e. the back surface) of Supports 1 and 2 and the adhesive surfaces of adhesive layers exposed by peeling the release sheet on the side with low peel strength (Support 2), and the charge potential half-time after the application was stopped, were measured using STATIC HONESTMETER H-0110 manufactured by Shishido Electrostatic Ltd.

(Measurement 2)

A double-sided adhesive sheet with release sheets was cut into a strip of 200 mm×50 mm, the release sheet on the side with low peel strength (Support 2) was peeled at 90° peel angle and 300 mm/minute peel speed, then, the release sheet on the side with high peel strength (Support 1) was peeled at 90° peel angle and 300 mm/minute peel speed, and the charge potentials of the respectively exposed adhesive surfaces of the adhesive layer 15 seconds after were measured at a measuring distance of 25 mm using Electrostatic Fieldmeter FMX-003 manufactured by SIMCO JAPAN.

(Evaluation)

Regarding frictional charging, if the equilibrium charge potential of either release sheet was 100 V or lower in Measurement 1, the determination was “[O(circle)]”, and the determination was “[X(cross)]” if 100 V was exceeded.

Regarding peeling charging, the determination was “[O(circle)]” if the half-time of the equilibrium charge potential of the adhesive surface exposed by peeling the release sheet (Support 2) was less than 60 seconds in Measurement 1, and the charge potential at 15 seconds after peeling either release sheet was less than 2.0 kV in Measurement 2, and “[X(cross)]” otherwise.

TABLE 1

| | | | Example | Example | Example | Comparative | Comparative | Comparative | Comparative |
|---|---|---|---|---|---|---|---|---|---|
| | | | 1 | 2 | 3 | Example 1 | Example 2 | Example 3 | Example 4 |
| Peel | Support 1 | (g/50 mm) | 95 | 180 | 130 | 100 | 90 | 143 | 180 |
| strength | Support 2 | | 52 | 50 | 60 | 48 | 60 | 50 | 52 |
| Static | Support 1 | Equilibrium | 43 | 82 | 3120 | 2990 | 2650 | 2720 | 3280 |
| electricity | | charge | | | | | | | |
| decay | | potential(V) | | | | | | | |
| behavior | Support 2 | Equilibrium | 2800 | 2900 | 38 | 2749 | 52 | 2827 | 2845 |
| | | charge | | | | | | | |
| | | potential(V) | | | | | | | |
| | Adhesive | Half-time | 9 seconds | 40 seconds | 14 seconds | 7 minutes | 9 minutes | 32 seconds | 18 seconds |
| | surface | | | | | 47 seconds | 23 seconds | | |
| Peeling | Support 1 | (kV) | 0.6 | 0.8 | 0.6 | 3.1 | 3 | 0.5 | 0.6 |
| charging | Support 2 | | 1.5 | 1.7 | 1.2 | 2.5 | 2.2 | 1.6 | 0.3 |
| potential | | | | | | | | | |

| | | | | | | | | |
|---|---|---|---|---|---|---|---|---|
| Evaluation | Frictional charging | ◯ | ◯ | ◯ | X | ◯ | X | X |
| | Peeling charging | ◯ | ◯ | ◯ | X | X | ◯ | ◯ |
| | Overall | ◯ | ◯ | ◯ | X | X | X | X |

When the results of Table 1 and the hitherto test results not shown in the specifications are considered, it was found that, if the adhesive layer side of either release sheet and the surface on the side opposite to the adhesive layer, i.e., the back surface, of at least one of the release sheets had electric conductivity as in Examples 1 to 3, charging of the adhesive layer could be prevented even if static electricity was generated when the release sheet was peeled, and furthermore, charging of the adhesive layer could be prevented even if static electricity was generated due to friction.

Above all, it was found that, when the peel strength between the first release sheet and the adhesive layer and the peel strength between the second release sheet and the adhesive layer were different, charging could be prevented all the more effectively by providing electric conductivity on the adhesive layer side of the release sheet with the greater peel strength between the release sheet and the adhesive layer.

From the results of Measurement 1, for the equilibrium charge potential of the back surface of at least one of the release sheets to be 100 V or lower and the charge potential half-time of the adhesive surface of the adhesive layer exposed when at least one of the release sheets is peeled to be less than 60 seconds was found to be desirable on the point of static electricity decay behavior.

In addition, consideration regarding peeling charging taken as well, for the half-time of the equilibrium charge potential of the adhesive surface exposed by peeling a release sheet (Support 2) to be less than 60 seconds and the charge potential 15 seconds after peeling either release sheet to be less than 2.0 kV was found to be desirable.

1. A pressure-sensitive adhesive sheet, comprising a pressure-sensitive adhesive layer and two release sheets layered on both the top and bottom sides of the pressure-sensitive adhesive layer,
wherein
a peel strength between one release sheet and the pressure-sensitive adhesive layer and a peel strength between the other release sheet and the pressure-sensitive adhesive layer are different, and
a pressure-sensitive adhesive layer side of at least one of the two release sheets, and a surface on a side opposite to the pressure-sensitive adhesive layer, of the at least one of the two release sheets have electric conductivity.

2. The adhesive sheet according to claim 1, wherein a pressure-sensitive adhesive layer side of a release sheet with a greater peel strength between said release sheet and the pressure-sensitive adhesive layer has electric conductivity.

3. The double sided pressure sensitive adhesive sheet with release sheets according to claim 1, wherein a pressure-sensitive adhesive layer side of a release sheet with a greater peel strength between said release sheet and the pressure-sensitive adhesive layer, and a back surface of either the one release sheet or the other release sheet have electric conductivity.

4. The adhesive sheet according to claim 1, wherein a charge potential of the sensitive adhesive sheet as measured according to JIS L1094 meets the following conditions (1) and (2):
(1) an equilibrium charge potential of a back surface of at least one of the one release sheet and the other release sheet is 100 V or lower; and
(2) a charge potential half-time of an exposed adhesive surface of the pressure-sensitive adhesive layer is less than 60 seconds when at least one of the one release sheet and the other release sheet is peeled.

5. The adhesive sheet according to claim 1, wherein the pressure-sensitive adhesive layer comprises a transparent material.

6. A method for manufacturing an integrated image display device, the method comprising filling a gap layer between a polarizer and a member with the according to claim 1.

7. The adhesive sheet according to claim 2, wherein a pressure-sensitive adhesive layer side of a release sheet with a greater peel strength between said release sheet and the pressure-sensitive adhesive layer, and a back surface of either the one release sheet or the other release sheet have electric conductivity.

8. The adhesive sheet according to claim 2, wherein a charge potential of the adhesive sheet as measured according to JIS L1094 meets the following conditions (1) and (2):
(1) an equilibrium charge potential of a back surface of at least one of the one release sheet and the other release sheet is 100 V or lower; and
(2) a charge potential half-time of an exposed adhesive surface of the pressure-sensitive adhesive layer is less than 60 seconds when at least one of the one release sheet and the other release sheet is peeled.

9. The adhesive sheet according to claim 2, wherein the pressure-sensitive adhesive layer comprises a transparent material.
